(19) United States
(12) Patent Application Publication
(10) Pub. No.: US 2005/0047788 A1
(43) Pub. Date: Mar. 3, 2005

(54) Optical pulse demultiplexer

(76) Inventor: Tetsuya Miyazaki, Tokyo (JP)

Correspondence Address: CHRISTIE, PARKER & HALE, LLP, PO BOX 7068, PASADENA, CA, 91109-7068, US

(21) Appl. No.: 10/917,108

(22) Filed: Aug. 11, 2004

(30) Foreign Application Priority Data
Aug. 28, 2003 (JP) 2003-303994

(51) Int. Cl. H04J 14/02

(52) U.S. Cl. 398/85

(57) ABSTRACT

In an optical pulse demultiplexer according to the invention, an optical splitter splits an input pulse signal light having a signal wavelength into a firs portion and a second portion. An optical clock generator generates an optical clock having a clock wavelength at a predetermined frequency corresponding to 1/n (n is integer not less than 2) of a bit rate of the input pulse signal light out of the first portion of the output lights from the optical splitter. The clock wavelength is different from the signal wavelength. A saturable absorption optical element, to which the optical clock generated by the optical clock generator and the second portion enter, separates a channel component corresponding to the predetermined frequency out of the second according to the optical clock. An optical filter extracts an optical component of the signal wavelength out of the light output from the saturable absorption optical element. A nonlinear waveform shaper suppresses a low level part of the light output from the first optical filter.

### CROSS REFERENCE TO RELATED APPLICATIONS

This application claims priority to Japanese Patent Application No. 2003-303994, filed Aug. 28, 2003, the entire contents of which are incorporated herein by reference.

### FIELD OF THE INVENTION

This invention generally relates to an optical pulse demultiplexer, and more specifically relates to an optical pulse demultiplexer to demultiplex an optical pulse of desired timing from a high-speed optical pulse train.

### BACKGROUND OF THE INVENTION

An ultra high-speed optical pulse signal is generated by time-division-multiplexing a plurality of optical pulse signals (tributary channels) for carrying data at the same reference bit rate (base rate). For instance, when the base rate is 10 Gb/s and the number of multiplexing signals is 16, an ultra high-speed pulse signal of 160 Gb/s is generated. In such case that an ultra high-speed optical pulse signal of a single wavelength is to be generated, a plurality of low-speed optical pulse signals of the same base rate are generated using a plurality of laser light of same wavelength made by dividing an output light from a single laser light source.

It is not possible to convert such ultra high-speed optical pulse signals in the intact state into electrical signals at a reception terminal. Accordingly, it is necessary to demultiplex the pulse signals of respective tributary channels from the optical pulse signal input from the optical fiber transmission. As apparatuses for demultiplexing low-speed optical pulse signals from an ultra high-speed optical pulse signal of 160 Gb/s or more, special high speed optical control optical switches, for example, an optical control optical switch using an NOLM (Nonlinear Optical Loop Mirror) and an optical control optical switch using SMZI (Symmetric Mach-Zehnder Interferometer), have been proposed See, for example, I. Shake et al., “160 Gbit/s full OTDM demultiplexing based FWM of SOA-array integrated on planer lightwave circuit,” Proc. 27^{th}, European Conference on Optical Communication (ECOC′ 01), Tul. 2. 2, pp. 182-183, 2001.

The optical regeneration technology using a self-phase modulation effect of a nonlinear medium is described in P. V. Mamyshev, “ALL-OPTICAL DATA REGENERATION BASED ON SELF-PHASE MODULATION EFFECT,” ECOC′ 98, 20-24 Sep. 1998, Madrid, Spain, pp. 475-476(“Mamyshev reference”).

Pulse demultiplexing characteristics of a conventional optical control optical switch are greatly affected by fluctuations of polarization and phase of an ultra high-speed optical pulse signal and control optical pulse signal. Furthermore, since these optical control optical switches use non-linear interference effects, the adjustments of the polarization and phase depend on each other, and therefore there are many pseudo optimum points. Accordingly, it is very difficult to optimally adjust the polarization and phase.

### SUMMARY OF THE INVENTION

An optical pulse demultiplexer according to one embodiment of the invention includes an optical splitter to split an input optical pulse signal with a signal wavelength into two portions, an optical clock generator to generate an optical clock having a clock wavelength at a predetermined frequency corresponding to 1/n (n is an integer not less than 2) of a bit rate of the input pulse signal light out of one portion of the output lights from the optical splitter. The clock wavelength is different from the signal wavelength. A saturable absorption optical element is also included. The optical clock generated by the optical clock generator and the other portion of the output lights from the optical splitter enter the saturable absorption optical element. This allows separation of a channel component corresponding to the predetermined frequency out of the other portion of the output lights from the optical splitter according to the optical clock. A first optical filter is also included to extract the optical component of the signal wavelength out of the output light from the saturable absorption optical element. A nonlinear waveform shaper is further included to suppress a low level part of the output light from the first optical filter.

According to this embodiment of the invention, by using saturable absorption optical elements, desired channel components are separated from an input signal light in the time domain with a little polarization-dependency. Furthermore, it is possible to suppress the other remaining channel components by providing a non-linear waveform shaper.

### BRIEF DESCRIPTION OF THE DRAWINGS

The above and other objects, features and advantages of the present invention will be apparent from the following detailed description of exemplary embodiments of the invention in conjunction with the accompanying drawings, in which:

FIG. 1 is a schematic block diagram of an exemplary embodiment according to the invention;

FIG. 2 is an output waveform embodiment of an optical bandpass filter 32;

FIG. 3 is a second output waveform embodiment of an optical bandpass filter 38; and

FIG. 4 is a schematic block diagram showing a clock regenerator 16 and a short pulse optical source 18.

### DETAILED DESCRIPTION

Exemplary embodiments of the invention are explained below in detail with reference to the drawings.

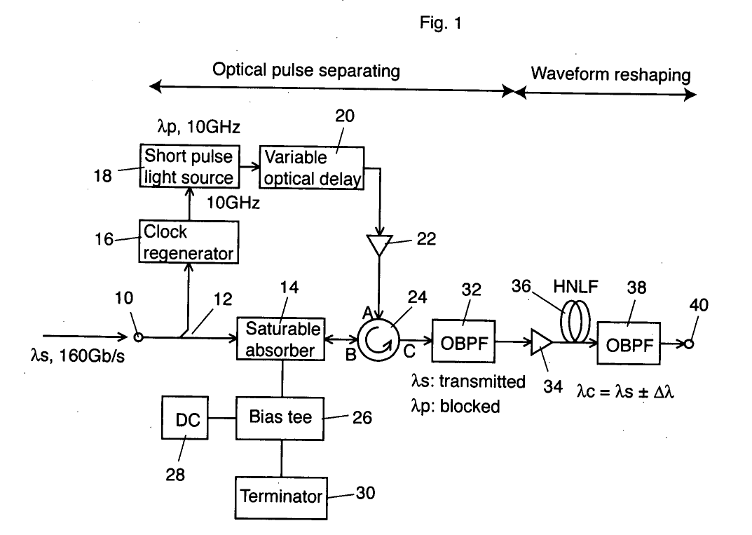

FIG. 1 shows a schematic block diagram of an exemplary embodiment according to the invention. In this embodiment, when an optical pulse signal of 160 Gb/s (16 data lights at a base rate of 10 Gb/s are time-division-multiplexed) enters an input terminal 10 from an optical transmission line, optical pulse signals of 10 Gb/s are demultiplexed from the input optical signal light.

An optical splitter 12 splits the optical pulse signal light of 160 Gb/s with a wavelength λs having entered the input terminal 10 into two portions. The optical splitter 12 applies one portion of the split lights to a saturable absorption optical element 14 having a cross-absorbing modulation effect and the other portion to a clock regenerator 16.

The saturable absorption optical element 14 is an element having such characteristics that the element 14 absorbs the signal wavelengths when no control optical pulse exists. When the control optical pulses exist, the element 14 absorbs the control optical pulses until it becomes saturated from the absorption of the signal wavelengths and the transmission factor of the signal wavelengths, therefore, becomes high. An electroabsorption optical modulator and an intersubband transition (ISBT) optical switch are examples of the saturable absorption optical element 14. Examples for using an electroabsorption optical modulator as a saturable absorption optical element are described in T. Mitsuma, S. Takasaki, K. Hirano, D. Uchida, N. Hoshi, H. Ishiki, K. Maezawa, H. Sasaki, M. Honda, N. Oka, H. Tanaka, and Y. Matsushima, “High reliable InGaAsP electro-absorption modulator module for 10 Gb/s operation,” in Proc. 8^{th} Int. Conf. Indiumu Phosphide Related Materials, 1996, TuP-C24, pp. 9-12. Details of an ISBT optical switch are described, for instance, in J. D. Heber, et al., Appl. Phys. Lett. Vol. 81, pp. 1237-1239, 2002, and Tomoyuki Akiyama, Nikolai Georgiev, Teruo Mozume, Haruhiko Yoshida, Achanta Venu Gopal, and Osamu Wada, “1.55 μm picosecond all-optical switching by using intersubband absorption in InGaAs-AlAs-AlAsSb coupled quantum wells” IEEE Photon. Tech. Lett., vol. 14, no. 4, pp. 495-497, 2002.

The clock regenerator 16 regenerates a clock pulse at a 10 Gb/s base rate out of the optical pulse signal at 160 Gb/s output (i.e., 1/n, where n=16) from the optical splitter 12. A short pulse optical source 18 outputs an optical clock pulse having a wavelength λp and a frequency 10 GHz according to the output clock from the clock regenerator 16. The output optical clock from the short pulse optical source 18 functions as a control light for the optical pulse separation in the saturable absorption optical element 14. Specifically, it functions as a control light to set a passing window of the saturable absorption optical element 14, so the optical clock must be a pulse light short enough for the separation. The output optical clock from the short pulse optical source 18 enters a port A of an optical circulator 24 through a variable optical delay 20 and an optical amplifier 22.

The optical circulator 24 outputs the optical clock from the optical amplifier 22 toward the saturable absorption optical element 14 through a port B. Owing to this operation, the optical pulse signal of wavelength λs and the optical clock of wavelength λp propagate in the opposite direction in the saturable absorption optical element 14. The delay time of the variable optical delay 20 is set so that the optical pulse signal of wavelength λs and the optical clock of wavelength λp enter the saturable absorption element 14 simultaneously.

A predetermined DC voltage is applied to the saturable absorption optical element 14 from a DC power supply 28 through a bias tee 26. The other terminal of the bias tee 26 is terminated by a terminator 30. The bias voltage of the saturable absorption optical element 14, the signal wavelength λs, and the clock wavelength λp are selected and set so that the absorption rate or transmission rate of the optical pulse signal light of the wavelength λs varies within a desired range according to whether the optical pulse of the wavelength λp exists.

The saturable absorption optical element 14 has a high transmission rate for the wavelength λs only when the optical pulse of the optical clock exists because of the cross-absorbing modulation effect, and it absorbs the wavelength λs under the other circumstances. Owing to the cross-absorbing modulation effect, the optical pulse signal of 10 Gb/s is demultiplexed from the signal light of 160 Gb/s.

Since the present embodiment utilizes the cross-absorbing modulation effect, the polarization dependency of the optical pulse signal and optical clock becomes lower, approximately by 0.5 dB, than that of an electroabsorption modulator, for example, used as the saturable absorption optical element 14.

The 10 Gb/s optical pulse signal of wavelength λs output from the saturable absorption optical element 14 enters the port B of the optical circulator 24 and outputs through a port C toward an optical bandpass filter (OBPF) 32. The optical bandpass filter 32 is set to transmit the wavelength λs and to refuse or block the wavelength λp. The optical bandpass filter 32 removes the mixed optical clock pulse generated by the short pulse optical source 18.

An optical amplifier 34 optically amplifies the output light from the optical bandpass filter 32 and applies the amplified light to a highly nonlinear fiber 36. Because of the nonlinear effects of the highly nonlinear fiber 36, a spectrum of the input light expands. The output light from the highly nonlinear fiber 36 is applied to an optical bandpass filter 38. A transmission central wavelength λc of the optical bandpass filter 38 is set to λs+Δλ or λs−Δλ. The optical bandpass filter 38 extracts wavelength components being shifted from the signal wavelength λs by Δλ, which is very slight, out of the output light from the highly nonlinear fiber 36. That is, by extracting the spectrum part expanded by the highly nonlinear fiber 36 using the optical bandpass filter 38, reshaping is realized. In addition, reamplifying is realized by the optical amplifier 34. The output light from the optical bandpass filter 38 is output toward the outside through an output terminal 40.

Although the details are described in the above-described Mamyshev reference, when optical intensity of the incident light of the highly nonlinear fiber 36 is not high enough so that the expansion of the spectrum by the highly nonlinear fiber 36 does not reach the transmission wavelength of the optical bandpass filter 38, the output from the optical bandpass filter 38 becomes zero. Conversely, when the optical intensity of the incident light of the highly nonlinear fiber 36 is high enough so that the spectrum expanded by the highly nonlinear fiber 36 exceeds the transmission wavelength of the optical bandpass filter 38, the optical bandpass filter 38 outputs lights having a constant optical intensity regardless of the strength of the optical intensity of the incident light of the highly nonlinear fiber 36. Owing to these functions, the optical pulse waveform of the output signal light from the optical bandpass filter 32 can be reshaped, and, furthermore, the low optical intensity part of the output signal light can be suppressed. In this embodiment, the latter function is used to suppress optical pulses in the other channels that the saturable absorption optical element 14 has failed to remove.

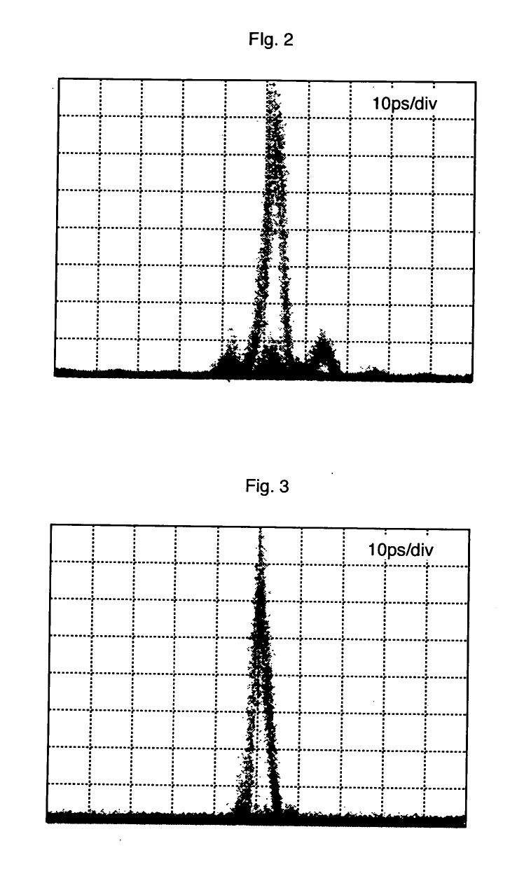

FIG. 2 shows an output waveform example of the optical bandpass filter 32, and FIG. 3 shows an output waveform example of the optical bandpass filter 38. In both FIGS. 2 and 3, the horizontal axis represents time (10 ps/div) and the vertical axis represents optical intensity. FIGS. 2 and 3 show that the demultiplexing by the saturable absorption optical element 14 alone is not satisfactory and that the exclusive demultiplexing of the desired channel can be realized only when the waveform shaping is used together with the pulse separation.

A waveform shaper using the self phase modulation effect of the highly nonlinear fiber 36, or a shaper using self Raman soliton effect may be used.

In the embodiment of FIG. 1, although the pulse signal light and the optical clock propagate in the opposite direction in the saturable absorption optical element 14, they may alternatively propagate in the same direction. In that case, instead of the optical circulator 24, an optical coupler (not shown) is disposed for coupling the pulse signal light and the optical clock to apply them to the saturable absorption optical element. On the output side of the saturable absorption optical element, the optical bandpass filter 32 is connected directly.

It is difficult to generate an electrical clock having a frequency 160 GHz or 160 GHz/integer directly from such a high-speed optical pulse train of 160 Gb/s. However, by superposing a tone signal on a signal light of 160 Gb/s beforehand on a transmission side, the tone signal having a frequency identical to the clock frequency used for time-division-demultiplexing, the function of the clock regenerator 16 is easily realized. For instance, when a signal light of 160 Gb/s is to be generated by time-division-multiplexing 16 optical pulse signal lights of 10 Gb/s, a tone signal of 10 GHz can be superposed on the 160 Gb/s signal light by changing the intensity or phase of one of the pulse signal lights from those of the remaining 15 pulse signal lights.

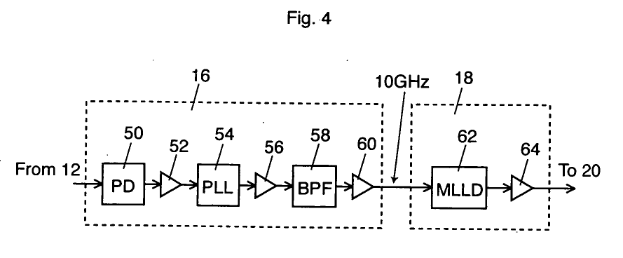

FIG. 4 shows a schematic block diagram of the clock regenerator 16 and the short pulse light source 18.

The signal light from the optical splitter 12 enters a photodetector 50 in the clock regenerator 16. The photodetector 50 converts the input signal light, or the optical pulse signal of 160 Gb/s here, into an electrical signal. As explained above, the input signal light includes a tone signal of frequency 10 GHz corresponding to a base rate (here, it is 10 Gb/s) and thus the output electrical signal from the photodetector 50 includes a frequency component of 10 GHz. The output from the photodetector 50 is amplified by an amplifier 52 and applied to a PLL circuit 54. The PLL circuit 54 outputs a clock pulse phase-locked with the output from the amplifier 52. The output from the PLL circuit 54 is amplified by an amplifier 56 and applied to a bandpass filter (BPS) 58. A center frequency of the bandpass filter 58 is 10 GHz. The BPF 58 removes components excluding the components of 10 GHz out of the output from the amplifier 56. The output from the BPF 58 is amplified by an amplifier 60 and applied to the short pulse light source 18.

The short pulse light source 18 is composed of a mode-locked laser (MLLD) 62 of a wavelength λp and an optical amplifier 64 for optically amplifying output light from the MLLD 62. The clock signal of 10 GHz output from the amplifier 60 in the clock regenerator 16 is applied to the MLLD 62 as a drive signal. With this operation, the MLLD 62 laser-pulse-oscillates at 10 GHz to output an optical clock of 10 GHz. The optical amplifier 64 optically amplifies the optical clock pulse output from the MLLD 62. The output light from the optical amplifier 64 is applied to the variable optical delay 20 as the output light from the short pulse light source 18.

While the invention has been described with reference to specific embodiments, it will be apparent to those skilled in the art that various changes and modifications can be made to the specific embodiment without departing from the spirit and scope of the invention as defined in the claims.

1. An optical pulse demultiplexer comprising:
an optical splitter to split an input pulse signal light having a signal wavelength into a first portion and a second portion;
an optical clock generator to generate an optical clock having a clock wavelength at a predetermined frequency corresponding to 1/n, where n is an integer not less than 2, of a bit rate of the input pulse signal light out of the first portion, the clock wavelength being different from the signal wavelength;
a saturable absorption optical element, to which the optical clock generator and the second portion enter, the saturable absorption optical element to separate a channel component corresponding to the predetermined frequency out of the second portion according to the optical clock;
a first optical filter to extract an optical component of the signal wavelength out of light output from the saturable absorption optical element; and
a nonlinear waveform shaper to suppress a low level part of light output from the first optical filter.

2. The optical pulse demultiplexer of claim 1 wherein the optical clock generator comprises:
a clock regenerator to regenerate an electrical clock having the predetermined frequency out of the first portion; and
an optical pulse light source to output the optical clock having the predetermined frequency according to the clock output from the clock regenerator.

3. The optical pulse demultiplexer of claim 1 or 2 wherein the nonlinear waveform shaper comprises:
an optical amplifier;
a nonlinear optical element to which an output light from the optical amplifier enters; and
a second optical filter to extract a wavelength component shifted from the signal wavelength by a predetermined wavelength out of an output light from the nonlinear optical element.
